(19) United States
(12) Patent Application Publication
(10) Pub. No.: US 2014/0014875 A1
(43) Pub. Date: Jan. 16, 2014

(54) PREPARATION METHOD OF INDUSTRIAL PURPLE NANO-NEEDLE TUNGSTEN OXIDE

(71) Applicants: Chonghu Wu, Xiamen City (CN); Qishan Wu, Xiamen City (CN); Xiao Wen, Xiamen City (CN); Gaoan Lin, Xiamen City (CN); Mandou Xiao, Xiamen City (CN); Hongbo Nie, Xiamen City (CN); Guanjin Gao, Xiamen City (CN); Chaoying Fan, Xiamen City (CN); Lili Ma, Xiamen City (CN)

(72) Inventors: Chonghu Wu, Xiamen City (CN); Qishan Wu, Xiamen City (CN); Xiao Wen, Xiamen City (CN); Gaoan Lin, Xiamen City (CN); Mandou Xiao, Xiamen City (CN); Hongbo Nie, Xiamen City (CN); Guanjin Gao, Xiamen City (CN); Chaoying Fan, Xiamen City (CN); Lili Ma, Xiamen City (CN)

(21) Appl. No.: 13/885,396

(22) PCT Filed: Mar. 30, 2011
(86) PCT No.: PCT/CN2011/072279

§ 371 Date: May 14, 2013

(51) Int. Cl. C01G 41/02

(52) U.S. Cl. CPC C01G 41/02
USPC 252/182.33

(57) ABSTRACT

In an industrial purple nano-needle tungsten oxide preparation method, ammonium paratungstate 5(NH₄)₂O.12WO₃.5H₂O, tungstic acid mWO₃.nH₂O (m≧1, n≧1), or tungsten oxide WOₓ (2≦x≦3) is used as a raw material for preparing the purple nano-needle tungsten oxide in an inclined rotating furnace pipe. At an inlet of the furnace pipe, the raw material is pushed from a feed inlet of a feeding device into the heated furnace pipe. The inclined furnace pipe is rotated to gradually move the raw material from a low temperature area to a high temperature area. The raw material at the high temperature area inside the furnace pipe is reduced by H₂ to form the nano-needle purple tungsten oxide. The inclined furnace pipe is rotated to move the WO_{2.72} towards a discharging end, and the purple tungsten oxide WO_{2.72} is discharged from a discharge outlet of a discharging device and cooled to room temperature by the discharging device.

### BACKGROUND OF THE INVENTION

1. Field of the Invention

The present invention relates to a preparation method of industrial purple nano-needle tungsten oxide.

2. Description of the Prior Art

Nanoscale tungsten powder (granularity≦100 nm) and ultrafine tungsten powder (100 nm≦granularity≦500 nm) are major raw materials used for preparing nanoscale tungsten carbide powder (granularity≦100 nm), ultrafine tungsten carbide powder (100 nm≦granularity≦500 nm) and ultrafine grain cemented alloy (100 nm≦granularity≦500 nm), and the nanoscale and ultrafine tungsten carbide powders and ultrafine grain cemented alloy are products of a relatively high add-on value in the present international market.

For example, using nano-needle purple tungsten oxide (Nano-needle WO_{2.72}) as a raw material and the Rayleigh instability principle and in-situ hydrogen reduction technology is an efficient way of preparing nanoscale and ultrafine tungsten powders, and the nano-needle purple tungsten oxide is a functional nanomaterial with a photochromic property, an electrochromic property and a gasochromic property and will be used in various different sensitive components in the future.

In view of the description above, nano-needle purple tungsten oxide has a very high value and an increasingly high demand in the market. Up to now, there is no report on the method of preparing nano-needle purple tungsten oxide in a large scale. Therefore, the inventor of the present invention designed a preparation method of industrial purple nano-needle tungsten oxide to meet market demands.

### SUMMARY OF THE INVENTION

It is a primary objective of the present invention to provide a preparation method of industrial purple nano-needle tungsten oxide to satisfy market demands.

To achieve the aforementioned objective, the technical solution taken by the present invention is described as follows:

In a preparation method of industrial purple nano-needle tungsten oxide, ammonium paratungstate 5(NH₄)₂O.12WO₃.5H₂O (APT), tungstic acid mWO₃.nH₂O (m≧1, n≧1), or tungsten oxide WOₓ (2≦x≦3) is used as a raw material; or tungsten oxide WOₓ ((2≦x≦3) in a product is used as a raw material in a certain preparation process, and the preparation takes place in an inclined rotating furnace pipe. At an inlet of the furnace pipe, the raw material is pushed from a feed inlet of a feeding device into a heated furnace pipe, and the inclined furnace pipe is rotated to gradually move the raw material from a low temperature area to a high temperature area, and the raw material in the furnace pipe is converted into nano-needle purple tungsten oxide WO_{2.72} by the H₂ in the high temperature area, and the inclined furnace pipe is rotated, the material is moved towards a discharge end, and the purple tungsten oxide WO_{2.72} is discharged from a discharge outlet by a discharging device and cooled by the discharging device to a temperature approximately equal to room temperature. The furnace pipe has a dedicated gas outlet formed thereon.

Preparation Mechanism:

(1) Ammonium paratungstate 5(NH₄)₂O.12WO₃.5H₂O is used as a raw material.

If the ammonium paratungstate 5(NH₄)₂O.12WO₃.5H₂O is heated to a temperature over 400° C., a reaction as shown in Equation (1) will take place to form yellow tungsten oxide WO₃, ammonia gas NH₃ and water vapor H₂O.

5(NH₄)₂O.12WO₃.5H₂O=12WO₃+10NH₃+10H₂O (1)

The ammonia gas NH₃ which is a reaction product in Equation (1) or the ammonia gas NH₃ inputted by other methods has a reaction as shown in Equation (2) under the catalysis of tungsten oxide WOₓ (2≦x≦3) to produce a reducing hydrogen gas H₂.

2NH₃=N₂+3H₂ (2)

If the reaction temperature rises over 500° C., the yellow tungsten oxide WO₃ which is a reaction product in Equation (1) will have a reduction reaction as shown in Equation (3) with the hydrogen gas H₂ which is a reaction product in Equation (2) and/or the hydrogen gas H₂ inputted by other methods to produce blue tungsten oxide WO_{2.9} and water vapor H₂O.

WO₃+0.1H₂=WO_{2.9}+0.1H₂O (3)

If the reaction temperature continues rising over 600° C., the blue tungsten oxide WO_{2.9} which is a reaction product in Equation (3) will have a reduction reaction as shown in Equation (4) with the hydrogen gas H₂ which is a reaction product in Equation (1) and/or the hydrogen gas H₂ inputted by other methods to produce purple tungsten oxide WO_{2.72} and water vapor H₂O.

WO_{2.9}+0.18H₂=WO_{2.72}+0.18H₂O (4)

In any one of Equation (1), Equation (3) and Equation (4), water vapor H₂O is produced. At high temperature, the water vapor H₂O can have a reversible reaction with the tungsten oxide WOₓ (2≦x≦3) as shown in Equation (5). The hydrated tungsten oxide WO₂(OH)₂ so produced is a gas at high temperature.

WOₓ+(4−x)H₂O≈WO₂(OH)₂+(3−x)H₂ (5)

Through the gas phase transport of the hydrated tungsten oxide WO₂(OH)₂, crystal nuclei of the purple tungsten oxide WO_{2.72} formed in Equation (4) grow to needle purple tungsten oxide WO_{2.72} crystals. Through the control of the quantity of wind extracted by an exhaust fan installed outside the gas outlet, the speed of discharging gas in the furnace pipe can be controlled to guarantee the positive pressure from 0 mbar to 5 mbars in the furnace pipe. If the WO₂(OH)₂ gas has appropriate partial pressure and temperature, the purple tungsten oxide WO_{2.72} needle crystal has a diameter smaller than 100 nm, which is considered as a nanomaterial.

(2) Tungstic acid mWO₃.nH₂O is used as a raw material, wherein m≧1, n≧1.

If the tungstic acid mWO₃.nH₂O is heated to a temperature over 100° C., a reaction as shown in Equation (6) will take place to form yellow tungsten oxide WO₃ and water vapor H₂O.

mWO₃.nH₂O=mWO₃+nH₂O (6)

By inputting ammonia gas NH₃ through a gas inlet, the ammonia gas NH₃ has a reaction as shown in Equation (2) under the catalysis of tungsten oxide WOₓ (2≦x≦3) to produce a reducing hydrogen gas H₂.

If the reaction temperature rises over 500° C., the yellow tungsten oxide WO₃ which is a reaction product in Equation (6) will have a reduction reaction as shown in Equation (3) with the hydrogen gas H₂ which is a reaction product in Equation (2) to produce blue tungsten oxide WO_{2.9} and water vapor H₂O.

If no ammonia gas NH₃ is inputted or the quantity of the inputted ammonia gas NH₃ is insufficient, hydrogen gas H₂ can be inputted from a gas inlet. If the reaction temperature rises over 500° C., the yellow tungsten oxide WO₃ which a reaction product in Equation (6) has a reduction reaction as described in Equation (3) with the hydrogen gas H₂ which is a reaction product in Equation (2) and/or the hydrogen gas H₂ inputted by other methods to produce blue tungsten oxide WO_{2.9} and water vapor H₂O.

If the reaction temperature continues rising over 600° C., the blue tungsten oxide WO_{2.9} which is a reaction product in Equation (3) will have a reduction reaction as described in Equation (4) with the hydrogen gas H₂ which is a reaction product in Equation (2) to produce purple tungsten oxide WO_{2.72} and water vapor H₂O. If no ammonia gas NH₃ is inputted or the quantity of the inputted ammonia gas NH₃ is insufficient, hydrogen gas H₂ can be inputted from a gas inlet.

If the reaction temperature rises over 600° C., the blue tungsten oxide WO_{2.9} which a reaction product in Equation (3) has a reduction reaction as described in Equation (4) with the hydrogen gas H₂ which is a reaction product in Equation (2) and/or the hydrogen gas H₂ inputted by other methods to produce purple tungsten oxide WO_{2.72} and water vapor H₂O.

In any one of Equation (6), Equation (3) and Equation (4), water vapor H₂O is produced. At high temperature, the water vapor H₂O can have a reversible reaction with the tungsten oxide WOₓ (2≦x≦3) as shown in Equation (5). The hydrated tungsten oxide WO₂(OH)₂ so produced is a gas at high temperature.

Through the gas phase transport of the hydrated tungsten oxide WO₂(OH)₂, crystal nuclei of the purple tungsten oxide WO_{2.72} formed in Equation (4) grow to needle purple tungsten oxide WO_{2.72} crystals. Through the control of wind extracted by an exhaust fan installed outside the gas outlet, the speed of discharging a gas in the furnace pipe can be controlled to guarantee the positive pressure from 0 mbar to 5 mbars in the furnace pipe. If the WO₂(OH)₂ gas has appropriate partial pressure and temperature, the purple tungsten oxide WO_{2.72} needle crystal has a diameter smaller than 100 nm, which is considered as a nanomaterial.

(3) Tungsten oxide WOₓ (2≦x≦3) is used as a raw material, or tungsten oxide WOₓ (2≦x≦3) in a preparation process and/or existed in a product is used as a raw material. Ammonia gas NH₃ and/or hydrogen gas H₂ are inputted from a gas inlet, and water vapor H₂O is inputted selectively according to different tungsten oxides WOₓ (2≦x≦3).

If ammonia gas NH₃ is inputted, the ammonia gas NH₃ has a reaction as described in Equation (2) under the catalysis of the tungsten oxide WOₓ (2≦x≦3) at high temperature to produce a reducing hydrogen gas H₂.

If the tungsten oxide WOₓ (2≦x≦3) includes yellow tungsten oxide WO₃ and the reaction temperature rises over 500° C., the yellow tungsten oxide WO₃ will have a reduction reaction as described in Equation (3) with the inputted hydrogen gas H₂ to produce blue tungsten oxide WO_{2.9} and water vapor H₂O.

If the reaction temperature continues rising over 600° C., the blue tungsten oxide WO_{2.9} which is a reaction product in Equation (3) will have a reduction reaction as described in Equation (4) with the inputted hydrogen gas H₂ to produce purple tungsten oxide WO_{2.72} and water vapor H₂O.

If the tungsten oxide WOₓ (2≦x≦3) includes blue tungsten oxide WO_{2.9} and the reaction temperature continues rising over 600° C., the blue tungsten oxide WO_{2.9} will has a reduction reaction as described in Equation (3) with the inputted hydrogen gas H₂ to produce purple tungsten oxide WO_{2.72} and water vapor H₂O.

In either one of Equation (3) and Equation (4), water vapor H₂O is produced. If the reaction as shown in Equation (3) and/or Equation (4) has produce insufficient quantity of water vapor H₂O, water vapor H₂O can be inputted through a gas inlet.

At high temperature, the water vapor H₂O produced in Equation (3) and/or Equation (4) and/or the inputted water vapor H₂O can have a reversible reaction with the tungsten oxide WOₓ (2≦x≦3) as shown in Equation (5) to produce hydrated tungsten oxide WO₂(OH)₂. The hydrated tungsten oxide WO₂(OH)₂ so produced is a gas at high temperature.

Through the gas phase transport of the hydrated tungsten oxide WO₂(OH)₂, crystal nuclei of the purple tungsten oxide WO_{2.72} formed in Equation (4) grow to is needle purple tungsten oxide WO_{2.72} crystals. Through the control of wind extracted by an exhaust fan installed outside the gas outlet, the speed of discharging gas in the furnace pipe can be controlled to guarantee the positive pressure from 0 mbar to 5 mbars in the furnace pipe. If the WO₂(OH)₂ gas has appropriate partial pressure and temperature, the purple tungsten oxide WO_{2.72} needle crystal has a diameter smaller than 100 nm, which is considered as a nanomaterial.

After the aforementioned solutions are adopted, the present invention can produce nano-needle purple tungsten oxide in mass production to meet the market demands.

The technical characteristics, contents, advantages and effects of the present invention will be apparent with the detailed description of a preferred embodiment accompanied with the illustration of related drawings as follows.

### BRIEF DESCRIPTION OF THE DRAWINGS

FIG. 1 is a spectral diagram of a cobalt (Co) target obtained after a X-ray diffraction (XRD) analysis of a product takes place in accordance with a first preferred embodiment of the present invention;

FIG. 2 is microscopic view of a sample of a product obtained by a Hitachi S-4800 II cold field emission scanning electron microscope in accordance with the first preferred embodiment of the present invention;

FIG. 3 is a spectral diagram of a Co target obtained after a XRD analysis of a product takes place in accordance with a second preferred embodiment of the present invention;

FIG. 4 is microscopic view of a sample of a product obtained by a Hitachi S-4800 II cold field emission scanning electron microscope in accordance with the second is preferred embodiment of the present invention;

FIG. 5 is a spectral diagram of a Co target obtained after a XRD analysis of a product takes place in accordance with a third preferred embodiment of the present invention; and

FIG. 6 is microscopic view of a sample of a product obtained by a Hitachi S-4800 II cold field emission scanning electron microscope in accordance with the third preferred embodiment of the present invention.

### DESCRIPTION OF THE PREFERRED EMBODIMENTS

In a first preferred embodiment of the present invention, ammonium paratungstate 5(NH₄)₂O.12WO₃.5H₂O is pushed from an inlet through a feed inlet of a feeding device into a heated furnace pipe, and gradually moved from a low temperature area to a high temperature area by the rotation of the inclined furnace pipe. If the ammonium paratungstate 5(NH₄)₂O.12WO₃.5H₂O falls within a temperature range from 400° C. to 600° C., a reaction as described in Equation (1) takes place to produce tungsten trioxide WO₃, ammonia gas NH₃ and water vapor H₂O.

The tungsten oxide WOₓ (2≦x≦3) which is a reaction product of Equation (1), Equation (3) and Equation (4) is a good catalysis for decomposing the ammonia gas NH₃, so as to have a thermal decomposition as described in Equation (2) of the ammonia gas NH₃ in the furnace pipe to produce a reducing hydrogen gas H₂.

The raw material is moved continuously towards the high temperature area by the rotation of the inclined furnace pipe. If the temperature of the raw material rises to 550° C.˜800° C., a reaction as described in Equation (3) takes place. If the temperature of the raw material rises to 750° C.˜800° C., a reaction as described in Equation (4) takes place to produce crystal nuclei of purple tungsten oxide WO_{2.72}.

In any one of Equation (1), Equation (3) and Equation (4), water vapor H₂O is produced.

The furnace pipe has a dedicated gas outlet, wherein the speed of discharging a gas in the furnace pipe can be adjusted by controlling the quantity of wind blown from an exhaust fan installed outside the gas outlet to guarantee a positive pressure from 0.2 mbar to 2.0 mbars in the furnace pipe.

At high temperature, the water vapor H₂O has a reversible reaction with the tungsten oxide WOₓ (2≦x≦3) as shown in Equation (5) to produce hydrated tungsten oxide WO₂(OH)₂. Through the gas phase transport of the hydrated tungsten oxide WO₂(OH)₂, crystal nuclei of the purple tungsten oxide WO_{2.72} formed in Equation (4) grow to needle purple tungsten oxide WO_{2.72} crystals.

When the inclined furnace pipe is rotated, the nano-needle purple tungsten oxide WO_{2.72} crystals continue moving towards a discharging end in the furnace pipe. The discharge end of the furnace pipe is not heated, so that the purple tungsten oxide WO_{2.72} can be cooled to a temperature approximately equal to room temperature and then discharged from a discharge outlet by a discharging device.

The purple tungsten oxide WO_{2.72} produced according to the first preferred embodiment is used as a sample, and the sample is grounded and the phase composition of the sample is analyzed by a PANalytical X'pert PRO XRD, Co target, with a scanning step of 0.033° and a stay of 10 s per step.

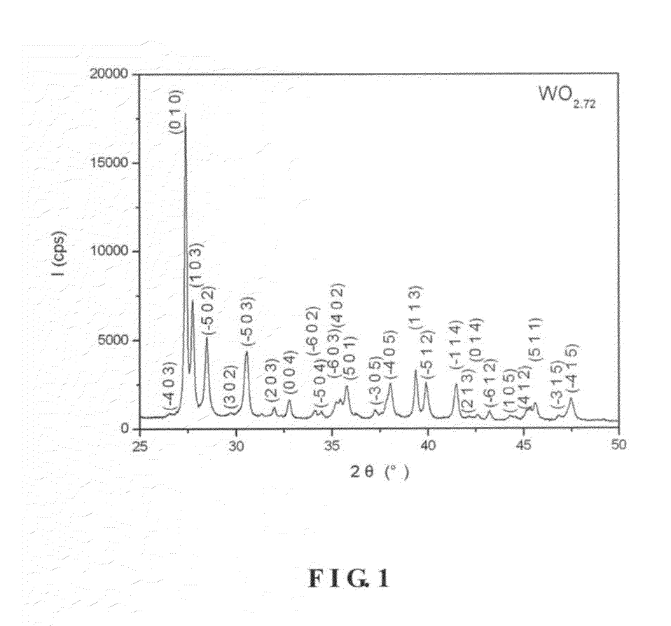

With reference to FIG. 1 for the spectrum obtained from the XRD analysis, the sample is purple tungsten oxide WO_{2.72} with a relatively pure phase.

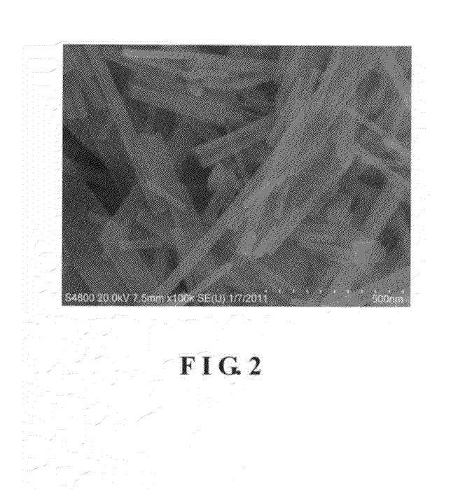

The purple tungsten oxide WO_{2.72} produced in the first preferred embodiment is used as a sample, and a Hitachi S-4800 II cold field scanning electron microscope is used to observe a microscopic view of the sample. In FIG. 2, the purple tungsten oxide WO_{2.72} needle crystal has a diameter from 20 nm to 80 nm, which is considered as a nanomaterial.

In a second preferred embodiment, tungstic acid mW_{O3}.nH₂O (wherein m=1, n=1) is pushed from an inlet through a feed inlet of a feeding device into a heated furnace pipe, and gradually moved from a low temperature area to a high temperature area by the rotation of the inclined furnace pipe. If the tungstic acid WO₃.H₂O falls within a temperature range from 100° C. to 300° C., a reaction as described in Equation (6) takes place to produce tungsten trioxide WO₃ and water vapor H₂O.

The ammonia gas NH₃ is inputted through a gas inlet, and the quantity of inputted ammonia gas NH₃ is controlled in a ratio of ammonia gas NH₃: tungstic acid WO₃.H₂O equal to 0.5 mo1˜1.5 mol:1 mol. The tungsten oxide WOₓ (2≦x≦3) is a good catalysis for decomposing the ammonia gas NH₃, so as to have a thermal decomposition as described in Equation (2) of the ammonia gas NH₃ in the furnace pipe to produce a reducing hydrogen gas H₂.

The raw material is moved continuously towards the high temperature area by the rotation of the inclined furnace pipe. If the temperature of the raw material rises to 550° C.˜800° C., a reaction as described in Equation (3) takes place. If the temperature of the raw material rises to 750° C.˜800° C., a reaction as described in Equation (4) takes place to produce crystal nuclei of purple tungsten oxide WO_{2.72}.

The furnace pipe has a dedicated gas outlet, wherein the speed of discharging a gas in the furnace pipe can be adjusted by controlling the quantity of wind blown from an exhaust fan installed outside the gas outlet to guarantee a positive pressure from 0.2 mbar to 2.0 mbars in the furnace pipe.

At high temperature, the water vapor H₂O has a reversible reaction with the tungsten oxide WOₓ (2≦x≦3) as shown in Equation (5) to produce hydrated tungsten oxide WO₂(OH)₂. Through the gas phase transport of the hydrated tungsten oxide WO₂(OH)₂, crystal nuclei of the purple tungsten oxide WO_{2.72} formed in Equation (4) grow to needle purple tungsten oxide WO_{2.72} crystals.

When the inclined furnace pipe is rotated, the nano-needle purple tungsten oxide WO_{2.72} crystals continue moving towards a discharging end in the furnace pipe. The discharge end of the furnace pipe is not heated, so that the purple tungsten oxide WO_{2.72} can be cooled to a temperature approximately equal to room temperature and then discharged from a discharge outlet by a discharging device.

The purple tungsten oxide WO_{2.72} produced according to the second preferred embodiment is used as a sample, and the sample is grounded and the phase composition of the sample is analyzed by a PANalytical X'pert PRO XRD, Co target, with a scanning step of 0.033° and a stay of 10 s per step.

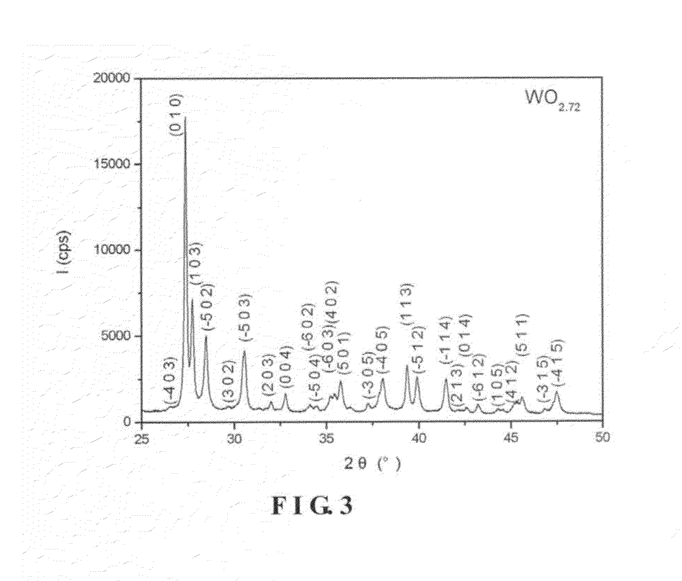

With reference to FIG. 3 for the spectrum obtained from the XRD analysis, the sample is purple tungsten oxide WO_{2.72} with a relatively pure phase.

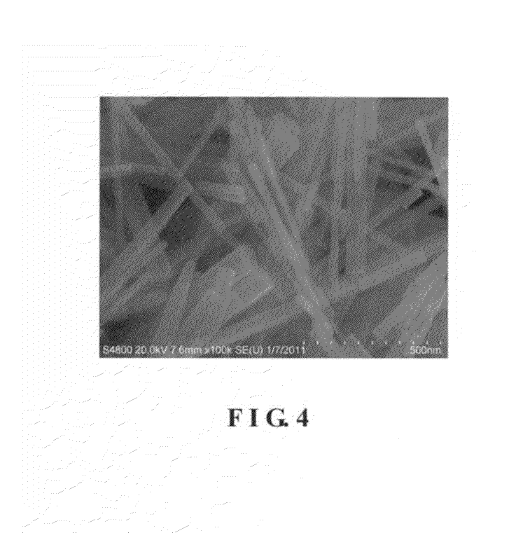

The purple tungsten oxide WO_{2.72} produced in the second preferred embodiment is used as a sample, and a Hitachi S-4800 II cold field scanning electron microscope is used to observe a microscopic view of the sample. In FIG. 4, the purple tungsten oxide WO_{2.72} needle crystal has a diameter from 20 nm to 80 nm, which is considered as a nanomaterial.

In a third preferred embodiment of the present invention, yellow tungsten oxide WO₃ is pushed from an inlet through a feed inlet of a feeding device into a heated furnace pipe, and gradually moved from a low temperature area to a high temperature area by the rotation of the inclined furnace pipe. If ammonia gas NH₃ and water vapor H₂O are inputted through a gas inlet, and the quantity of inputted ammonia gas NH₃ is controlled in a ratio of ammonia gas NH₃: yellow tungsten oxide WO₃ equal to 0.5 mol˜1.5 mol:1 mol. The tungsten oxide WOₓ (2≦x≦3) is a good catalysis for decomposing the ammonia gas NH₃, so as to have a thermal decomposition as described in Equation (2) of the ammonia gas NH₃ in the furnace pipe to produce a reducing hydrogen gas H₂.

The raw material is moved continuously towards the high temperature area by the rotation of the inclined furnace pipe. If the temperature of the raw material rises to 550° C.˜800° C., a reaction as described in Equation (3) takes place. If the temperature of the raw material rises to 750° C.˜800° C., a reaction as described in Equation (4) takes place to produce crystal nuclei of purple tungsten oxide WO_{2.72}.

The furnace pipe has a dedicated gas outlet, wherein the speed of discharging a gas in the furnace pipe can be adjusted by controlling the quantity of wind blown from an exhaust fan installed outside the gas outlet to guarantee a positive pressure from 0.2 mbar to 2.0 mbars in the furnace pipe.

At high temperature, the water vapor H₂O has a reversible reaction with the tungsten oxide WOₓ (2≦x≦3) as shown in Equation (5) to produce hydrated tungsten oxide WO₂(OH)₂. Through the gas phase transport of the hydrated tungsten oxide WO₂(OH)₂, crystal nuclei of the purple tungsten oxide WO_{2.72} formed in Equation (4) grow to nano-needle purple tungsten oxide WO_{2.72} crystals.

When the inclined furnace pipe is rotated, the nano-needle purple tungsten oxide WO_{2.72} crystals continue moving towards a discharging end in the furnace pipe. The discharge end of the furnace pipe is not heated, so that the purple tungsten oxide WO_{2.72} can be cooled to a temperature approximately equal to room temperature and then discharged from a discharge outlet by a discharging device.

The purple tungsten oxide WO_{2.72} produced according to the third preferred embodiment is used as a sample, and the sample is grounded and the phase composition of the sample is analyzed by a PANalytical X'pert PRO XRD, Co target, with a scanning step of 0.033° and a stay of 10 s per step.

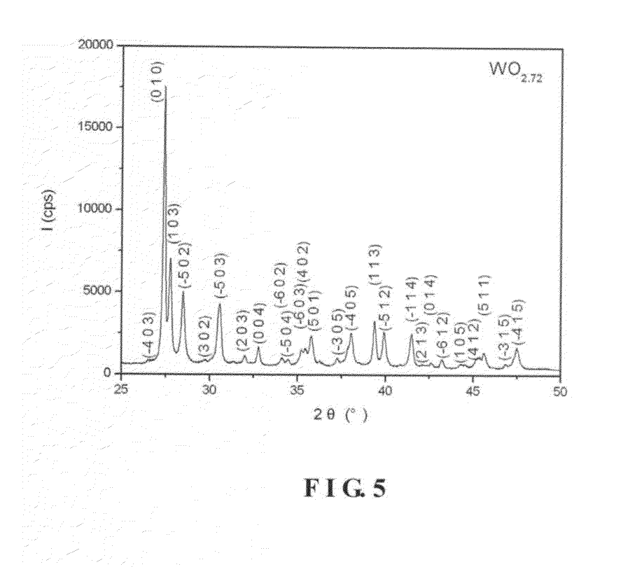

With reference to FIG. 5 for the spectrum obtained from the XRD analysis, the sample is purple tungsten oxide WO_{2.72} with a relatively pure phase.

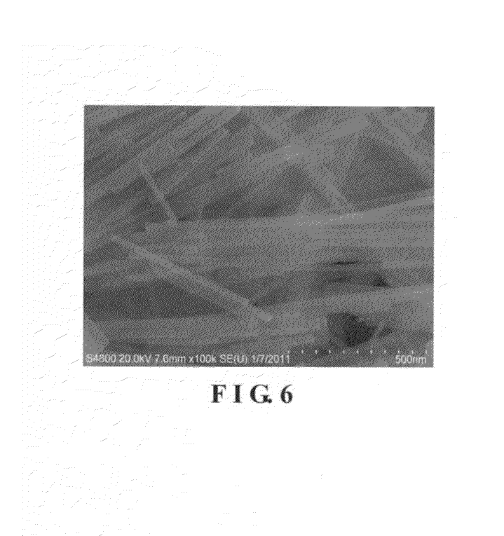

The purple tungsten oxide WO_{2.72} produced in the third preferred embodiment is used as a sample, and a Hitachi S-4800 II cold field scanning electron microscope is used to observe a microscopic view of the sample. In FIG. 6, the purple tungsten oxide WO_{2.72} needle crystal has a diameter from 20 nm to 80 nm, which is considered as a nanomaterial.

What is claimed is:

1. A preparation method of nano-needle purple tungsten oxide, characterized in that ammonium paratungstate 5(NH₄)₂O.12WO₃.5H₂O is used as a raw material, and the method comprises the steps of:
(A) pushing the ammonium paratungstate 5(NH₄)₂O.12WO₃.5H₂O through a feed inlet of a feeding device into a heated furnace pipe, and moving the ammonium paratungstate 5(NH₄)₂O.12WO₃.5H₂O gradually from a low temperature area to a high temperature area while the inclined furnace pipe is being rotated;
(B) heating and decomposing the ammonium paratungstate 5(NH₄)₂O.12WO₃.5H₂O into tungsten trioxide WO₃, ammonia gas NH₃ and water vapor H₂O;
(C) thermally decomposing the ammonia gas NH₃ in the furnace pipe to produce reducing hydrogen gas H₂; and
(D) moving the raw material to the high temperature area while the inclined furnace pipe is rotating, such that when the temperature of the raw material continues rising, the tungsten trioxide WO₃ is reduced gradually by the hydrogen gas H₂ to produce purple tungsten oxide WO_{2.72}.

2. The preparation method of nano-needle purple tungsten oxide according to claim 1, wherein the inclined furnace pipe inputs the ammonia gas NH₃ and/or hydrogen gas H₂ through a gas inlet.

3. The preparation method of nano-needle purple tungsten oxide according to claim 1, wherein the ammonium paratungstate 5(NH₄)₂O.12WO₃.5H₂O is heated at a temperature over 400° C.

4. The preparation method of nano-needle purple tungsten oxide according to claim 1, wherein the produced purple tungsten oxide WO_{2.72} is controlled with a reaction temperature over 600° C.

5. The preparation method of nano-needle purple tungsten oxide according to claim 1, wherein the furnace pipe has a gas outlet disposed at an end of the furnace pipe, and an exhaust fan installed outside the gas outlet for controlling the speed of discharging a gas and guaranteeing a positive pressure from 0 mbar to 5 mbars in the furnace pipe.

6. A preparation method of nano-needle purple tungsten oxide, characterized in that tungstic acid mWO₃.n H₂O is used as raw material, m≧1, n≧1, and the method comprises the steps of:
(A) pushing the tungstic acid mWO₃.nH₂O through a feed inlet of a feeding device into a heated furnace pipe, and moving the tungstic acid mWO₃.nH₂O gradually from a low temperature area to a high temperature area while the inclined furnace pipe is being rotated;
(B) heating and decomposing the tungstic acid mWO₃.nH₂O into tungsten trioxide WO₃ and water vapor H₂O; and
(C) continuing moving the raw material to the high temperature area while the inclined furnace pipe is rotating, such that when the temperature of the raw material continues rising, the tungsten trioxide WO₃ is reduced gradually by the hydrogen gas H₂ to produce purple tungsten oxide WO_{2.72}.

7. The preparation method of nano-needle purple tungsten oxide according to claim 6, wherein the inclined furnace pipe inputs the ammonia gas NH₃ through a gas inlet, and thermally composes the ammonia gas NH₃ in the furnace pipe to produce a reducing hydrogen gas H₂.

8. The preparation method of nano-needle purple tungsten oxide according to claim 6, wherein the inclined furnace pipe inputs the hydrogen gas H₂ or a mixed gas of the ammonia gas NH₃ and the hydrogen gas H₂ through a gas inlet.

9. The preparation method of nano-needle purple tungsten oxide according to claim 6, wherein the tungstic acid mWO₃.nH₂O is heated at a temperature over 100° C.

10. The preparation method of nano-needle purple tungsten oxide according to claim 6, wherein the produced purple tungsten oxide WO_{2.72} is controlled at a reaction temperature over 600° C.

11. The preparation method of nano-needle purple tungsten oxide according to claim 6, wherein the furnace pipe has a gas outlet disposed at an end of the furnace pipe, and an exhaust fan installed outside the gas outlet for controlling the speed of discharging a gas and guaranteeing a positive pressure from 0 mbar to 5 mbars in the furnace pipe.

12. A preparation method of nano-needle purple tungsten oxide, characterized in that tungsten oxide WOₓ, 2≦x≦3 is used as raw material, and the method comprises the steps of:
(A) pushing the tungsten oxide WOₓ through a feed inlet of a feeding device into a heated furnace pipe, and moving the tungsten oxide WOₓ gradually from a low temperature area to a high temperature area while the inclined furnace pipe is being rotated; and
(B) continuing moving the raw material to the high temperature area while the inclined furnace pipe is rotating, such that when the temperature of the raw material continues rising, the tungsten oxide WOₓ is reduced gradually by the hydrogen gas H₂ to produce purple tungsten oxide WO_{2.72}.

13. The preparation method of nano-needle purple tungsten oxide according to claim 12, wherein the inclined furnace pipe inputs the ammonia gas NH₃ through a gas inlet, and thermally composes the ammonia gas NH₃ in the furnace pipe to produce a reducing hydrogen gas H₂.

14. The preparation method of nano-needle purple tungsten oxide according to claim 12, wherein inclined furnace pipe inputs the hydrogen gas H₂ or a mixed gas of the ammonia gas NH₃ and the hydrogen gas H₂ through a gas inlet.

15. The preparation method of nano-needle purple tungsten oxide according to claim 12, wherein the inclined furnace pipe inputs the water vapor H₂O through a gas inlet.

16. The preparation method of nano-needle purple tungsten oxide according to claim 12, wherein the produced purple tungsten oxide WO_{2.72} is controlled at a reaction temperature over 600° C.

17. The preparation method of nano-needle purple tungsten oxide according to claim 12, wherein the furnace pipe has a gas outlet disposed at an end of the furnace pipe, and an exhaust fan installed outside the gas outlet for controlling the speed of discharging a gas and guaranteeing a positive pressure from 0 mbar to 5 mbars in the furnace pipe.
